(19) United States
(12) Patent Application Publication
(10) Pub. No.: US 2019/0219205 A1
(43) Pub. Date: Jul. 18, 2019

(54) Hose Clamp

(71) Applicant: NORMA Germany GmbH, Maintal (DE)

(72) Inventors: Oliver Leusner, Taunusstein (DE); Helmut Geppert, Karlstein (DE); Gerrit von Breitenbach, Karlstein (DE); Linda Breideband, Frankfurt am Main (DE); Michael Sommer, Büdingen (DE); Michael Lenz, Schöneck (DE)

(73) Assignee: NORMA Germany GmbH, Maintal (DE)

(21) Appl. No.: 16/315,888

(22) PCT Filed: Jun. 29, 2017
(86) PCT No.: PCT/EP2017/066184

§ 371 Date: Jan. 7, 2019

(30) Foreign Application Priority Data
Jul. 7, 2016 (DE) 102016112531.8

(51) Int. Cl. F16L 33/035; F16L 33/08

(52) U.S. Cl. CPC F16L 33/035; F16L 33/04; F16L 33/08

(57) ABSTRACT

The disclosure relates to a clamp (1), comprising a clamp band (2) extending in a peripheral direction (U) and a tensioning device (7) for tensioning the clamp band (2). According to an embodiment, in order to form the clamp (1) with yielding properties during tensioning and from a minimal number of structural components, the clamp band (2) has structures (11, 12) that extend at the edges (5, 6) of the clamp band.

### INTRODUCTION

The present disclosure relates to a hose clamp having a clamp band which extends in a peripheral direction and having a clamping device for clamping the clamp band.

An example of a generic hose clamp is set out in U.S. Pat. No. 4,308,648 A1. The hose clamp has a clamping device via which a clamp band can be clamped, for example, around a hose end or the like. The clamping device has to this end a clamping screw which is rotatably received in a housing of the clamping device. In this instance, as a result of a thread of the clamping screw, the clamp band, which on the outer side thereof has a corresponding engagement geometry for the thread, can be pulled into the housing of the clamping device. During clamping, the diameter of the hose clamp decreases accordingly and radial clamping forces are produced.

If hose clamps are fitted to rigid pipe ends or the like, it may be the case, for example, in the event of significant temperature changes, that the material resilience of the clamp band is not adequate in order, for example, in the event of a temperature-related expansion of the pipe end or the like, to prevent a clamping excess rise in the clamp band. Also, without an inherent resilience of the clamp band, for example, a minimum clamping force is not reached when the hose or pipe is pulled together so that the hose clamp may become released.

It is known to provide an additional resilience as a result of an undulating region of the clamp band, for which additional elements, such as an ondular washer and an ondular washer bridge are provided. The hose band consequently has a plurality of individual components, which have to be joined together during production. The ondular washer, the ondular washer bridge and a portion of the clamp band additionally have to be connected to each other. In this case, at the inner side, the ondular washer bridge acts as an abutment against the hose or the pipe so that the abutment is not interrupted by the undulating region of the ondular washer. On the whole, consequently, a complex construction is produced with a plurality of individual components which have to be provided and connected to each other for the production of the hose clamp.

DE 31 30 092 A1 sets out an alternative embodiment of a hose clamp having a clamp band which extends in a peripheral direction and having a clamping device for clamping the clamp band, wherein the clamp band itself has an undulating structure. Consequently, diameter changes of the hose can be compensated for, wherein the compensation is produced as a result of an inherent resilience of the clamp band in the peripheral direction. In a disadvantageous manner, in a state distributed over the periphery, the abutment of the clamp band, for example, against a non-resilient particularly round member, is not ensured over the entire periphery thereof, but is instead interrupted in the region of the undulating structure. Therefore, there may be occurrences of leakage in connection with high pressure lines.

### SUMMARY

An object of the disclosure is to develop a hose clamp (referred to below as a clamp) having a clamp band which extends in a peripheral direction and having a clamping device for clamping the clamp band, wherein the clamp is also intended to have a secure fit over a relatively long period of time and with changing temperatures. In this instance, in particular high levels of sealing are intended to be ensured.

This object is achieved according to an embodiment on the basis of a clamp having a clamp band which extends in a peripheral direction having a first edge and a second edge and having a first end and a second end and having a clamping device for clamping the clamp band at the first end in that the clamp band has in each case on the first edge a radially flared first structure and on the second edge a radially flared second structure.

The disclosure is based on the notion of providing a modification to the undulating structure according to the prior art by the first structure and the second structure each extending in an axial direction, wherein the first structure is connected to the first edge and the second structure is connected to the second edge. The first structure and the second structure additionally extend in a radial direction. The possibility is thereby afforded for the clamp band to provide, over the entire peripheral direction via a geometry which is provided between the structures, a contact against the surface of the member, via which the clamping force of the clamp is transmitted. The structures provide the clamp band with an inherent resilience with regard to tensile loads and bending loading which is brought about by the shape of the structures. As a result of this inherent resilience, for example, temperature-related diameter changes of the hose or the pipe can be compensated for.

According to an embodiment, the first structure and the second structure are each formed by formations which are periodically repeated in the peripheral direction. In this instance, formations which are arranged on the first edge form the first structure and formations which are arranged on the second edge form the second structure. A regular surface of the clamp band with homogeneous resilient properties is thereby achieved. Consequently, when clamping the clamp, a uniform transmission of the clamping force to clamped members is achieved.

Further, there is provision for the formations to have a variable cross-section in an axial direction. In addition, there is provision for the radial extent of the formations to be variable in an axial direction. There is provision in this instance for the formations at the outer side of the clamp band to extend radially outward. As a result of the fact that the formations in the peripheral direction have a variable cross-section, the resilience of the clamp band is different for loads in a peripheral direction in the axial direction. Surfaces of the members which are intended to be clamped and which are not located so as to be coplanar with the clamp band can thus also be gripped to a limited degree by the clamping of the clamp band. As a result, the abutment face of the clamp band is increased.

Furthermore, there is provision in an embodiment for the formations of the structures to extend in an axial direction from the respective edge over a center axis of the clamp band, wherein the formations of the first structure and the formations of the second structure are arranged alternately in a peripheral direction. One advantage of this embodiment is that the formations of the structures are arranged in a regular manner although the formations of the structures are arranged either on the first or on the second edge of the clamp band. As a result of the regular arrangement of the formations, the distribution of the resilient properties of the clamp band in the region in which the structures are arranged is also homogeneous. An extremely uniform transmission of the clamping force to the member to be clamped is thereby achieved.

Further, the structures are arranged in a structure portion of the clamp band. This embodiment enables the clamp band to have additional portions. For instance, the clamp band may have a portion which is used for the clamping thereof.

In an embodiment, the first structure has with respect to the second edge and the second structure has with respect to the first end an edge spacing. In addition, the formations of the first structure and the formations of the second structure further have an intermediate spacing with respect to each other in the peripheral direction. There is further provision for a value of the edge spacings to substantially correspond in each case to a value of the intermediate spacings. In an embodiment, the edge spacings and the intermediate spacings form within the structure portion a planar geometry of the clamp band.

This planar geometry can be brought into contact with the surface of the member on which the clamp is fitted. The compression which is applied by the clamping of the clamp to the member is in this instance transmitted via the planar geometry. As a result of the fact that the geometry is formed in a peripheral direction by the intermediate spacings and the edge spacings, the geometry with an alternating arrangement of the formations of the structures in the peripheral direction is continuous. A uniform securing of the member with the clamp is thereby achieved, wherein the clamp is always positioned over the entire periphery. Consequently, in particular in the case in which a resilient second member (for example, a hose) is arranged between a first member (for example, a flange) and the clamp, a fluid-tight and pressure-tight connection can be ensured.

According to an embodiment, there is provision for the clamp band to have at least one portion without one of the structures. The at least one portion without one of the structures has a thread embossing which can be arranged at the second end of the clamp band. In this instance, the second end of the clamp band can run into the clamping device at the first end of the clamp band when this is operated to clamp the clamp band. To this end, the clamping device may have a clamping screw and a housing so that the entire clamp with the clamp band is formed in a ready-to-operate state from a total of at least three structural components. The three structural components are finally formed by the clamping screw, the housing and the clamp band which can be connected to each other by corresponding joining methods, in particular punching/bending methods. In an embodiment, there may be provision for the clamping device to be constructed integrally with the clamp band and to be able to be formed by punching/bending methods from the clamp band. As a result of the integral construction of the clamp band with the clamping device or the production of an at least three-part clamp in a punching/bending method, the production of the clamp is facilitated so that the production costs of the clamp are low.

According to an embodiment, the formations of the structures are constructed as conical peripheral portions. In this instance, the structures have on the respective edges against which they are in abutment a substantially undulating form. The undulation peaks extend outward in a radial direction. The undulation troughs do not extend inward in a radial direction. The structures may at the respective edges also have other shapes, such as, for example, a triangular shape or a trapezoidal shape or other polygonal shapes which preferably extend outward in a radial direction. In an axial direction, the clamp band then has bulges which are brought about by the shape of the structures on the respective edge and which form the formations of the structures.

In an embodiment, there is further provision for the formations of the structures to each have a notch. The notches form material recesses and can be produced particularly preferably in a non-machined manner. As a result of the notches of the formations, the resilience of the clamp band is further increased.

There is provision for the clamp to have a central notch at least partially along the center axis. In this instance, there is provision for the notch along the center axis to have a width which can be configured in accordance with the desired rigidity matrix of the clamp.

In, the width of the notch is smaller than or equal to three times the thickness or the material thickness of the clamp band. In an embodiment, the notch is constructed in such a manner that the surface of the member which is intended to be clamped cannot be clamped by the edges of the notch which extend parallel with the center axis. The material thickness of the clamp band is in an embodiment between 0.1 mm and 1.5 mm, preferably between 0.4 and 1.0 mm and in a specific embodiment between 0.6 and 0.8 mm.

In an embodiment, there is provision for the clamp along the center axis to be separated at least partially along a separation path. Preferably, a degree of flexibility of the clamp in an axial direction is thereby produced. As a result of this flexibility, the clamp can be better adapted to an uneven surface of the member which is intended to be clamped. In an embodiment, the clamp has at two locations along the center axis at least partially separation paths, in another embodiment the clamp has at three locations along the center axis at least partially separation paths.

In an embodiment, there is further provision for there to be formed in the clamp band at least partially along the center axis a central notch which extends through the structures. As a result of the notch, the flexibility of the clamp in an axial direction is increased.

### BRIEF DESCRIPTION OF THE FIGURES

Other measures which improve the disclosure are illustrated in greater detail below together with the description of an embodiment with reference to the Figures, in which:

FIG. 1: is a schematic view of a clamp having a clamp band which is constructed with features of the disclosure,

FIG. 2: is a detailed view of the clamp band with formations which are formed by conical peripheral portions,

FIG. 3: is a detailed view of the clamp band with formations which are constructed on the edge of the clamp band in a trapezoidal manner,

FIG. 4: is a detailed view of the clamp band with formations which have notches,

FIG. 5: is a detailed view of the clamp band with a notch on the center axis, and

FIG. 6: is a detailed view of the clamp band which has a separation on the center axis.

### DETAILED DESCRIPTION

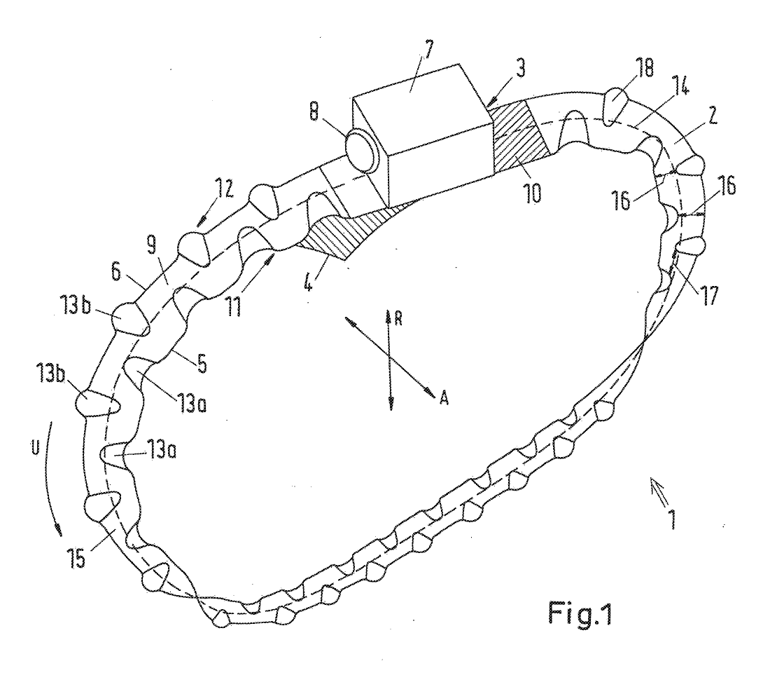

FIG. 1 shows a clamp 1 having a clamp band 2 which has a first end 3, a second end 4, a first edge 5 and a second edge 6. Furthermore, the clamp has a clamping device 7 having a clamping screw 8 and the clamp band 2 has a structure portion 9 and an additional portion having a thread embossing 10. The clamping device 7 is arranged on the first end 3 of the clamp band 2 whilst the thread embossing 10 is arranged on the second end 4 of the clamp band 2. There is arranged between the first end 3 and the portion with the thread embossing 10 the structure portion 9 inside which on the first edge 5 a first structure 11 and on the second edge 6 a second structure 12 are arranged. The structures 11, 12 are composed in each case of formations 13a, 13b which are arranged alternately in a peripheral direction U and which extend from the respective edge 5, 6 over the center axis 14. Therefore, the formations 13 extend in an axial direction A. Furthermore, the formations 13 extend in a radial direction R whilst they are arranged on the outer side 15 of the clamp band 2. The formations 13 are spaced apart from the respective opposing edge by an edge spacing 16. The formations are spaced apart from each other via an intermediate spacing 17. In FIG. 1, the formations are constructed as conical peripheral portions 18.

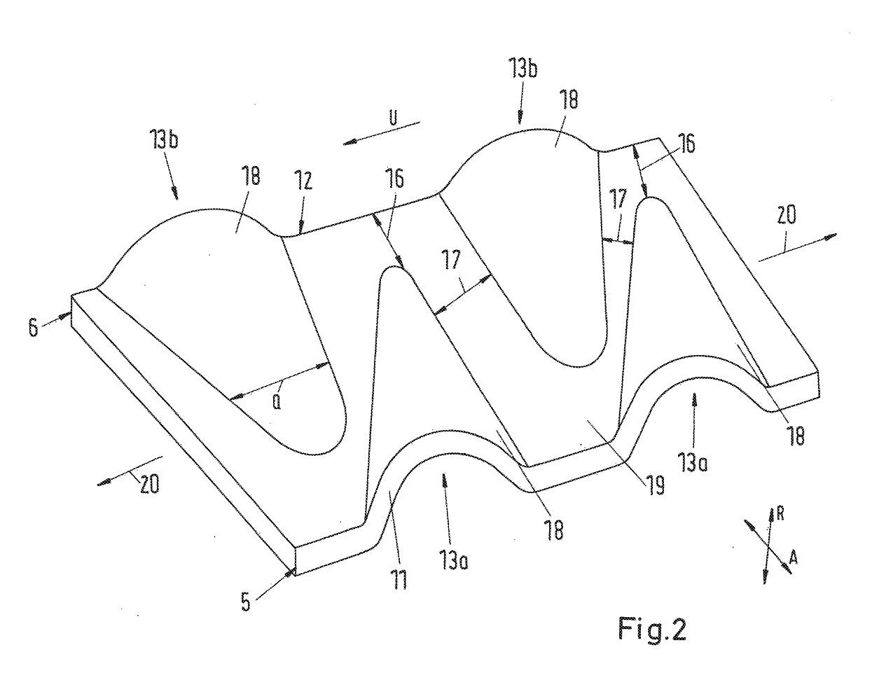

FIG. 2 is a detailed illustration of a structure portion 9 with formations 13a, 13b which are constructed as conical peripheral portions 18. The formations 13 are distinguished in that they are formed on the edge 5, 6 of the clamp band 2 by an undulating structure and have a variable cross-section Q. The edge spacing 16 and the intermediate spacing 17 form a geometry 19 which extends continuously in the structure portion 9. The conical peripheral portions 18 have a degree of resilience in the event of loading in the peripheral direction U so that, when a band pulling force 20 is applied, the clamp band 2 is expanded along the structure portion 9.

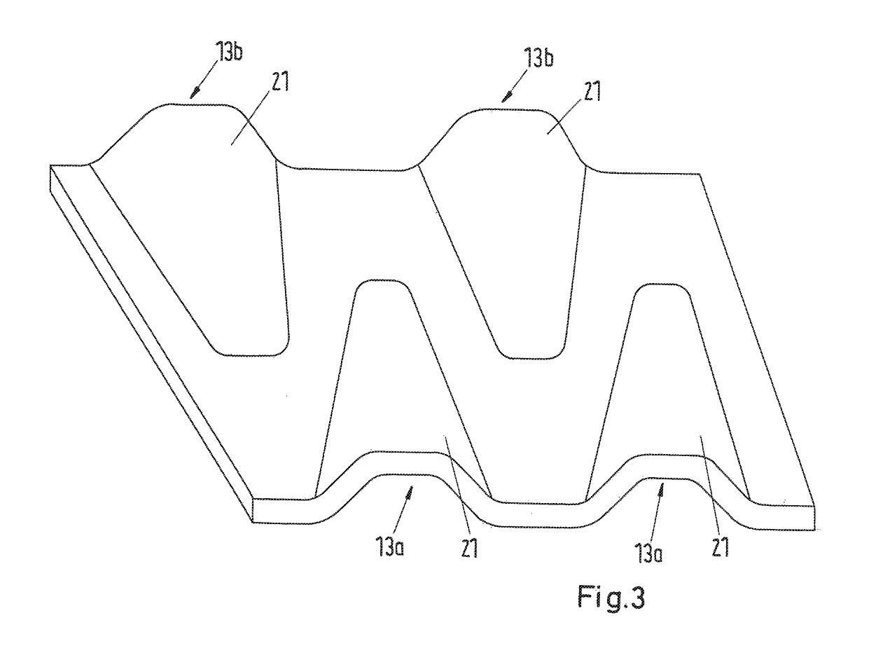

FIG. 3 is a detailed illustration of a structure portion 9 with formations 13 which are formed on the edge 5, 6 of the clamp band 2 by a trapezoidal structure 21. The trapezoidal structure 21 has rounded corners.

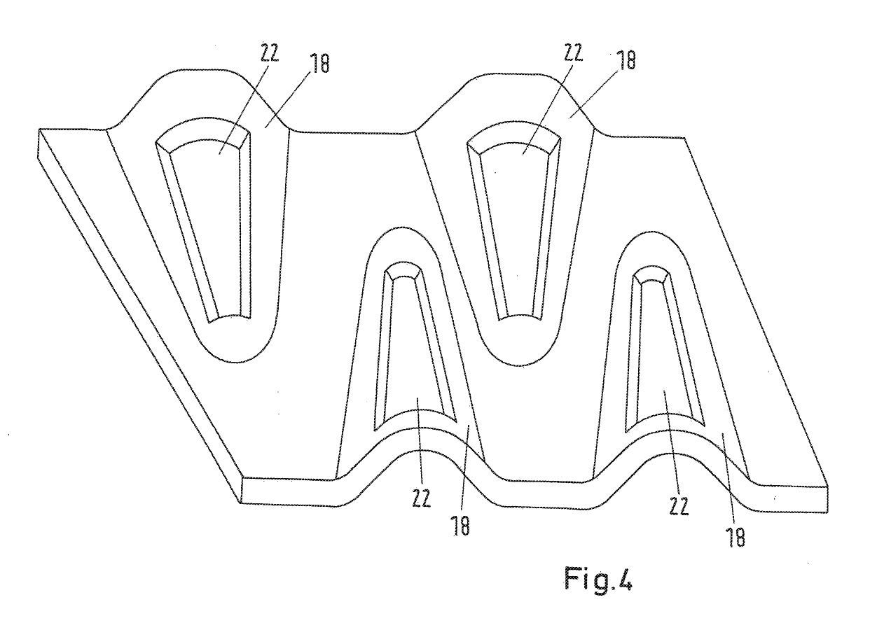

FIG. 4 is a detailed illustration of a structure portion 9 with conical peripheral portions 18 which each have a notch 22 in a region which extends in a radial direction R. As a result of the notch 22, the resilience of the structure portion 9 is further increased.

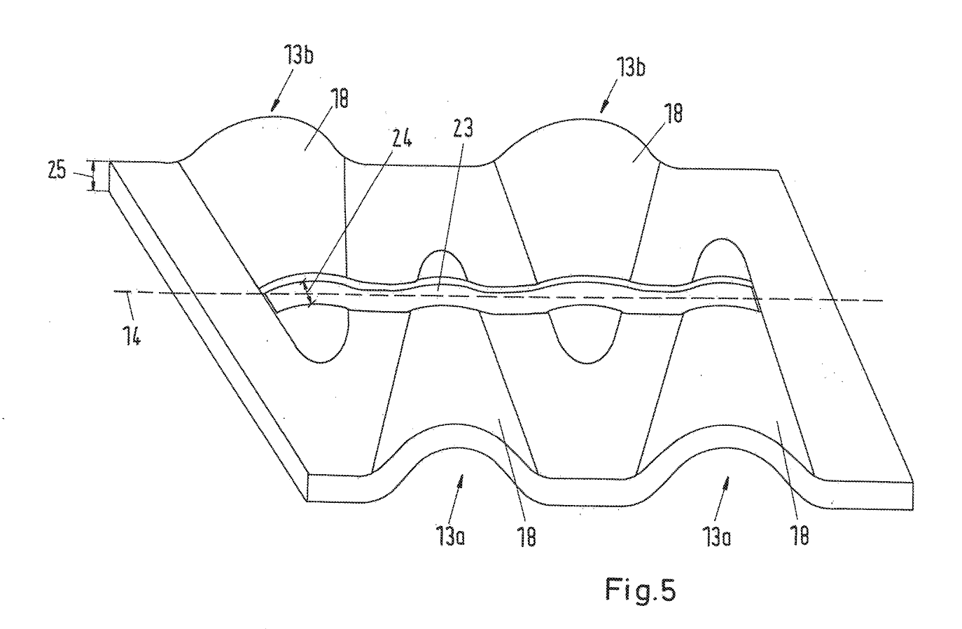

FIG. 5 is a detailed illustration of a structure portion 9 with conical peripheral portions 18, wherein a central notch 23 is constructed parallel with the center axis 14. The notch has a width 24 which is up to three times the material thickness 25 of the clamp band 2. As a result of the notch 23, the flexibility of the clamp band in an axial direction A is increased.

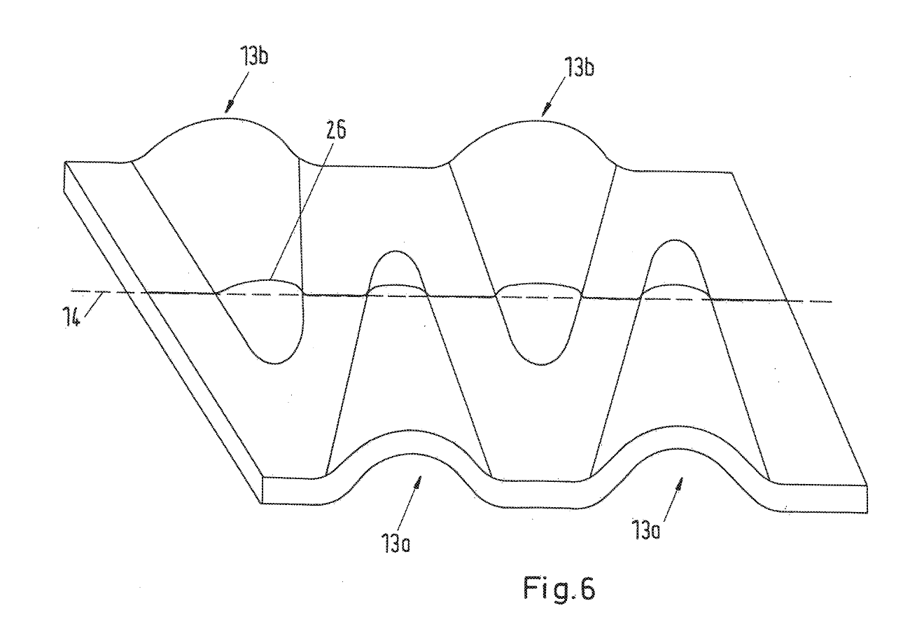

FIG. 6 is also a detailed illustration of a structure portion 9 with conical peripheral portions 18, wherein the clamp band 2 is separated parallel with a center axis 14 along a separation path 26. The clamp band 2 may in addition to the separation path 26 have additional separation paths parallel with the center axis 14.

The invention is not limited in terms of its implementation to the preferred embodiments set out above. Instead, a number of variants which also make use of the illustrated solution with embodiments which are in principle constructed in a different manner are conceivable.

All the features and/or advantages which can be derived from the claims, the description or the drawings, including structural details or spatial arrangements, may be significant for the invention both per se and in extremely different combinations.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

1 Clamp
2 Clamp band
3 First end
4 Second end
5 First edge
6 Second edge
7 Clamping device
8 Clamping screw
9 Structure portion
10 Thread embossing
11 First structure
12 Second structure
13a,b Formations
14 Center axis
15 Outer side
16 Edge spacing
17 Intermediate spacing
18 Conical peripheral portion
19 Geometry
20 Band pulling force
21 Trapezoidal structure
22 Notch
23 Central notch
24 Width
25 Material thickness
26 Separation path
A Axial direction
Q Cross-section
R Radial direction
U Peripheral direction

1. A clamp comprising a clamp band which extends in a peripheral direction (U) having a first end and a second end and having a first edge and a second edge and having a clamping device for clamping the clamp band, wherein the clamp band has in each case on the first edge a radially flared first structure and on the second edge a radially flared second structure.

2. The clamp as claimed in claim 1, wherein the first structure and the second structure are each formed by formations which are periodically repeated in the peripheral direction (U).

3. The clamp as claimed in claim 2, wherein the formations have a variable cross-section (Q) in an axial direction (R).

4. The clamp as claimed in claim 2, wherein the formations of the structures extend in an axial direction (A) from the respective edge over a center axis of the clamp band, wherein the formations of the first structure and the formations of the second structure are arranged alternately in a peripheral direction (U).

5. The clamp as claimed in claim 1, wherein the structures are arranged in a structure portion of the clamp band.

6. The clamp as claimed in claim 1, wherein the first structure has with respect to the second edge and the second structure has with respect to the first edge an edge spacing.

7. The clamp as claimed in claim 2, wherein the formations of the first structure and the formations of the second structure in each case have an intermediate spacing with respect to each other in the peripheral direction.

8. The clamp as claimed in claim 7, wherein a value of the edge spacings substantially correspond in each case to a value of the intermediate spacings.

9. The clamp as claimed in claim 1, wherein the clamp band has at least one portion without one of the structures.

10. The clamp as claimed in claim 9, wherein the at least one portion without one of the structures has a thread embossing.

11. The clamp as claimed in claim 2, wherein the formations of the structures are constructed as conical peripheral portions.

12. The clamp as claimed in claim 2, wherein the formations of the structures each have a notch.

13. The clamp as claimed in claim 1, wherein in the clamp band there is formed at least partially along a center axis of the clamp band a central notch which extends through the structures.
